(19) United States
(12) Patent Application Publication
(10) Pub. No.: US 2006/0080273 A1
(43) Pub. Date: Apr. 13, 2006

(54) Middleware for externally applied partitioning of applications

(75) Inventors: Louis R. Degenaro, White Plains, NY (US); Isabelle Rouvellou, New York, NY (US); Jian Yin, Ossining, NY (US); Adolfo F. Rodriguez, Raleigh, NC (US)

Correspondence Address: IBM CORPORATION, T.J. WATSON RESEARCH CENTER, P.O. BOX 218, YORKTOWN HEIGHTS, NY, 10598, US

(73) Assignee: International Business Machines Corporation, Armonk, NY (US)

(21) Appl. No.: 10/963,461

(22) Filed: Oct. 12, 2004

(51) Int. Cl. G06F 17/30

(52) U.S. Cl. 707/1

(57) ABSTRACT

A method for routing an application request to servers hosting the application for improved performance and scalability. Routing of the request is accomplished by allocating each partition of an externally defined set of application associated partitions to at least one of the servers hosting the application; by classifying the application request in consideration of its contents according to external criteria; and by assigning the classified application request to one of the partitions; and finally by routing the classified application request to one of said servers hosting the partition.

### BACKGROUND OF THE INVENTION

1. Field of the Invention

The present invention generally relates to distributed application systems. More specifically, the present invention relates to methods and apparatus for routing requests to distributed applications.

2. Description of Related Art

Much effort has gone into designing distributed systems to allow for horizontal scalability. One approach is to run application clones on separate servers and load balance requests across them. Load balancing of requests can occur at the client itself, or through some intermediary, such as a router, or at the server where requests are received then forwarded. Load balancing can increase throughput and performance for certain types of distributed applications; but for those where contention for resources occurs, the benefits realized may be small, or worse, the distributed application may perform more poorly than if it were a singleton.

Load balancing does not take into account the nature of a request. It only considers how much work a server is carrying out based upon server performance evaluation criteria. Thus, load balancing decisions alone for routing of requests may not be the most effective or desirable ones.

An example of a poorly performing distributed application follows. Presume there are three servers, A, B, and C all running a cloned stock trading application; and three requests to trade IBM stock arrive in close proximity followed by a request to trade Intel stock. The load balancer sends one request to trade IBM stock to each of the servers. Now, as server A is processing the first trade IBM stock transaction, servers B and C are waiting to execute their assigned IBM stock trades due to contention for the IBM stock trade resources, and the request to trade Intel stock continues to wait in queue until one of the servers becomes available.

To improve performance and scalability, some (See U.S. Pat. No. 6,393,415 “Adaptive Partitioning Techniques in Performing Query Requests and Request Routing”, Getchius et al.) have employed distributed caches. This works well in some situations, but not so well in others. For example, if the data are read-only and the cache size is infinite, then caching all referenced data works well. But when the cache size is limited, then replicating the same data across multiple servers may not be the most effective way to employ the caches. Moreover, when the data are read-write, then the effort to coordinate the caches may be prohibitively expensive.

Known in the related art is to employ a primary/backup server mechanism, and a load balancing primary server reassignment mechanism (See U.S. Patent Application Publication US005828847A “Dynamic Server Switching for Maximum Server Availability and Load Balancing”, Gehr et al.). But such mechanisms do not use any insight into data access or other patterns for partitioning of requests. Thus, for example, data access contention is not purposefully reduced and optimal performance is not realized. Further, flexibility and scalability are limited to a primary and a backup server.

Also known in the related art is to employ partitioning of data on disk for separable components (See US Patent US006480932 “Computer System Having a Host Computer Coupled to a Disk Drive with a Drive-Selected-Application Partition for Storing Data for Execution by the Host Computer in Response to Drive-Determined Conditions”, Vallis et al.). For example, the data on disk might be divided into two partitions: “system” and “user”. Presumably, a user would never access system data and vice-versa. The prior art does not target application requests for similar data. For example, there is no ability to do partitioning of requests by database row access where requests for odd rows go to server 1 and requests for even rows go to server 2. Database partitioning techniques alone are unconcerned with routing of requests.

In the related art, some have suggested a design pattern that encourages isolation of resource requirements between sets of requests by partitioning into equivalence classes (see “Resource Rationalizer: A Pattern Language for Multi-Scale Scheduling”, Gill et al., PLOP Conference 2002). Then isolation relationships between equivalence classes can provide a variety of resource usage assurances. But how to accomplish these tasks in not disclosed. And how partitioning is related to routing is not disclosed. The prior art does not facilitate declaration of equivalence classes via externally specified regular expressions or hashing functions which associate a request with a partition, and isolation via partition to server assignment.

Also in the related art, some are concerned with allocation of hardware resources by requests to a parallel system composed of many nodes (see “Architecture-Independent Request-Scheduling with Tight Waiting-Time Estimations”, Gehring and Ramme, Job Scheduling Strategies for Parallel Processing Workshop 1996). For example, a request may be for a number of processors for an estimated occupation time. Requested resources may not be available and the request must be rejected or queued. An intermediary is placed between the requester(s) and the provider(s) to make decisions on when and which resources to allocate, if any. Scheduling and queuing techniques are employed. The prior art relative to parallel processing is not directed toward a (usually) web-based software application responding to requests, and as such has different operating characteristics. For example, not all requests can be logically handled by a single server. Multiple servers (e.g., application clones) are not possible or may not produce desired effects in a horizontally scalable manner.

The prior art includes work that, for each application, requires programmers to author additional code that performs operations to transform, aggregate, cache, and customize web content (see “Cluster-Based Scalable Network Services”, Fox et al., ACM SIGOPS Operating Systems Review 1997). By doing so, applications are shielded from the complexity of automatic scaling, high availability, and failure management. But the prior art requires that an application be written and deployed incorporating code modifications. Routing for improved performance or other reasons is applied internally. Thus, the application itself must be aware that partitioning is occurring through examination of requests and decisions to route individual requests to identical copies of the application deployed on different servers.

The prior art also discloses a locality-aware request distribution, based solely on the URI+query string (see “Locality-Aware Request Distribution in Cluster-based Network Servers”, Pai et al., ACM Conference on Architectural Support for Programming Languages and Operating Systems 1998). Thus, HTTP requests “/abc/1” and “/abc/2” are different targets. This may lead to a large target namespace and consequently to a large overhead at design time, run time, or both. The prior art does not offer a classification step that classifies a request into a partition. The prior art does not necessarily promote desired distribution. For example, failing to insure that “abc/1” and “abc/2” are both processed on the same server fosters mistakes whereby separate partitions might be incorrectly located on separate servers, thus causing, for example, contention for resources. The prior art has problems with scalability and performance, for example, with read-write data.

The prior art includes mail services for which data is frequently written and where good performance, availability, and manageability at high volume are required (see “Manageability, Availability and Performance in Procupine: A Highly Scalable, Cluster-based Mail Service”, Saito et al., SOSP 1999). The mail services provide functional homogeneity, where any node can perform any function; fault-tolerance; load balancing of store and retrieve operations across nodes in a cluster; and dynamic addition or deletion of nodes, with the remaining nodes sharing the workload without human intervention. However, when load balancing mail messages, there are no write conflicts for individual messages. For example, a mail message, once written, is usually just read, not modified. Thus, the competition for resource is not per mail message, but just for a place to write it once. The prior art is unable to handle high transaction rates for single instances (i.e., individual messages themselves are not updatable in a scalable and fault-tolerant way. Also, the prior art here does not promote single copy consistency (see “Transaction Processing: Concepts and Techniques”, Gray and Reuter, 1993).

Known in the prior art are data-dependent routing facilities, where a request is routed to a server within a specific group based on a data value within the request (BEA Systems “Tuxedo”, Release 6.5, February 1999). These facilities allow for database segmenting and data-dependent routing to reach the groups dealing with separable segments for improved performance. But the prior art only allows selection of one field for classification; only allows for primary and backup nodes; and requires clients and server to pass information using a field manipulation language. Thus, the application itself is an active participant in classification, partitioning, and routing.

Finally, also known in the prior art is to partition an application by function, either statically or dynamically (see “Fun with Partitioning”, Linthicum, DBMS September 1997). For example, the part of the application that performs function X runs on server A and the part of the application that performs function Y runs on server B. This is different from the types of applications addressed by the present invention, as described herein, wherein the same functionality is provided by all servers, but the data accessed is partitioned in an externalized fashion, completely (or mostly) unknown to the application.

### SUMMARY OF THE INVENTION

To significant advantage, the present invention has none of the above limitations.

The present invention facilitates complete routing flexibility through user-specifiable regular expressions or externalized multidimensional selection criteria to externally apply classification and partitioning functions to select the target server for the request. The present invention also facilitates dynamic reassignment of partitions to any available node, not just a statically chosen primary and backup. Further, the present invention operates on any standard request format, such as HTTP or IIOP.

The present invention offers an important and easy to use facility enabling well considered distribution of requests to application servers for improved performance and scalability. Each request is classified and partitioned according to externalized criteria, then routed to a server hosting the determined partition. The present invention is flexible in that all externalized criteria, including classification, partition definitions, and partition placement, are dynamically updatable during runtime. The present invention can be applied to existing distributed applications without modifying them.

The present invention comprises a general purpose middleware that facilitates externally applied classification of requests for routing to externally partitioned distributed applications for improved operating characteristics, such as performance and scalability.

### BRIEF DESCRIPTION OF THE DRAWINGS

The teachings of the present invention can be readily understood by considering the following detailed description in conjunction with the accompanying drawings, in which:

FIG. 1 is a diagram showing a runtime architecture for partitioned routing of classified requests to a distributed application;

FIG. 2 is text representation of an example externalized classification, partitioning and placement data file.

### DETAILED DESCRIPTION

With respect to the stock trading example cited above, a better approach, and one made possible with the present invention, would be to send all three requests to trade IBM stock to server A, since these requests must contend for the same IBM stock trade resources; and send the request to trade Intel stock to server B. Thus, unbeknownst to the distributed stock trading application itself, its performance can be improved by an externally applied partitioned load balancing technique.

There may be other reasons for routing requests, other then optimizing response time for all users of an application. An enterprise may wish to favor a subset of users, call them GOLD customers, by providing them with the best possible response time, even though SILVER and BRONZE customers may suffer. Thus, it may be desirable to route GOLD customers' requests to a collection of servers having plenty of excess capacity, while routing others to less well endowed servers.

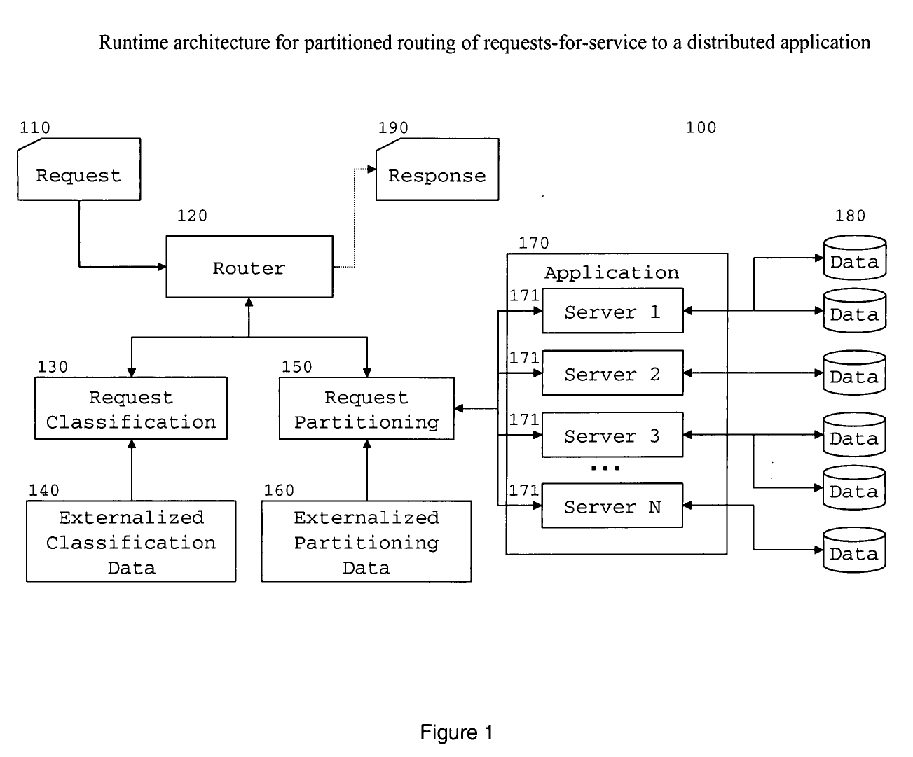

Referring now to FIG. 1, a diagram shows one example of a runtime architecture for partitioned routing of requests for service to a distributed application. Relationships among various entities, components, or software modules comprising one exemplary embodiment according to the present invention are illustrated. The elements comprise a request (110); a request router (120); a request classifier (130); externalized classification criteria (140); a classified request partitioner (150); externalized partitioning criteria (160); a distributed application (170) deployed on multiple application servers (171) hosting partitions; data created, retrieved, updated, and deleted by the distributed application (180); and an optional response (190).

A request (110) could be an HTTP request, such as “http://www.ibm.com/?user=degenaro”, or an IIOP request such as “login(degenaro)”, or any other suitable request. A request router (120) could be, for example, an On-Demand Router (ODR) acting as a caching proxy to which requests are initially directed for service. Such an ODR would employ the classifier (130) and partitioner (150) to select a destination server for each request. The request router (120) may examine the contents of a request (110) and/or associated meta-data for consideration in routing the request. It may pass some or all of this information to the classifier (130) and partitioner (150) for use in performing the classification and partitioning tasks respectively.

The request classifier (130) employs externalized classification criteria (140) to make a classification of a request (110). For example, an HTTP request such as https://www.e-trader.com/user=decgenaro,buy=IBM,shares=100,price=90 might be classified as “IBM” according to one externalized classification criteria instance. According to a different externalized classification criteria instance the same HTTP request might be classified as a “GOLD” customer.

A classified request partitioner (150) employs externalized partitioning criteria (160) to assign a classified request to a partition. For example, a request classified as “IBM” to may be assigned to a “FORTUNE-500-TRADE” partition; according to a different externalized partitioning criteria instance the same HTTP request might be assigned to an “IBM-TRADE” partition; and according to yet another externalized partitioning criteria instance the same HTTP request might be assigned to a “HIGH-PRIORITY” partition.

Distributed applications (170), servers (171), application data (180) and corresponding request responses (190) are well known in the art. The present invention uses these resources to greater advantage by improving horizontal scalability of deployed distributed application (170) on servers (171) by routing requests destined for a cluster intelligently, not just considering, for example, server load balancing based upon CPU consumption.

Horizontal scalability is the ability to distribute the workload of application requests while maintaining or improving response time and throughput. That is, horizontal scalability is the ability of a distributed system to handle more workload simply by adding more application servers. For example, presume an application has been distributed onto 4 servers. Without horizontal scalability, the workload may be distributed in such fashion that the maximum number of requests per second that can be serviced is 10, due to competition for resources, even though 2 additional servers are added to the cluster. By classifying, partitioning, and routing requests in consideration of their content, requests can be directed in a more effective manner so that the same 4 servers might service 20 or more requests per second, and adding 2 additional servers may improve response time and/or enable 30 or more requests per second.

The insight here is that even though a CPU may be lightly loaded in relative terms, it may not be the best choice for routing a request. External examination of request contents and routing intelligently can lead to improved horizontal scalability though the method disclosed by the present invention. External examination means that the application itself need not be an intelligent request routing participant.

The present invention provides controlled scalability through classification, partitioning, and placement. A classification of a set of requests could be into classes “A” and “B”; or into classes “A”, “B”, and “C”; and so forth into any suitable classifications. The classification step can be scaled according to needs over time. Likewise, classified requests can be grouped into partitions. For example, requests classified as “A” or “B” might be associated with partition “1”, while requests classified as “”C” or “D” might be associated with partition “2”. Thus, the partitioning step can also be scaled according to needs over time. Finally, the association of a partition with a server can also be scaled. For example, initially Server SI may host the set of partitions {“1”, “2”, “3”} and the server S2 may host the set of partitions {“4”, “5”, “6”}; at a different point in time, Server S1 may host {“1”, “3”}, Server S2 may host {“4”, “6”}, and Server S3 may host {“2”, “5” }. Thus the placement of partitions can be scaled over time.

The application may be able to use externally applied content-aware scalable request routing to even greater advantage through, for example, aggressive caching. Aggressive caching may be in the form, for example, of batching database accesses. The caching may occur at the application level or by the container (EJB, Web, etc.) into which the application is deployed.

Prior to runtime, an initial setup is determined and deployed. The classification criteria (140) and the partitioning and partition placement criteria (160) for a subject distributed application (170) are created by inspection, intuition, knowledge of the relationship between requests and application behavior, or other suitable means. Once created, these criteria (140, 160) along with the subject distributed application (170) are deployed into the runtime environment. Other elements of the present invention, such as an improved On-Demand Router (120) and request classification (130) and request partitioning (150) facilities can be pre-installed.

The subject distributed application (170) is constructed and deployed in the usual way. For example, a Java 2 Enterprise Edition (J2EE) web application is authored and an Enterprise ARchive (EAR) file is created. The EAR file is then deployed onto each member of a cluster of application servers (171) providing web container services. The distributed application is thus replicated on each application server (171) in the usual way.

The application servers (171) also provide session Enterprise Java Bean (EJB) services as well as high availability services, such as a reliable Bulletin Board (BB) used for communications by deployed entity instances across the cluster of servers. Other suitable mechanisms to carry out the tasks of managing runtime partitioning information include, but are not limited to, a Universal Communication Facility (UCF) and a Java Message Service (JMS). Managing runtime partition information comprises reliably maintaining partition location information as well as services for dynamic partition relocation, addition, and removal through program interfaces and user-oriented commands.

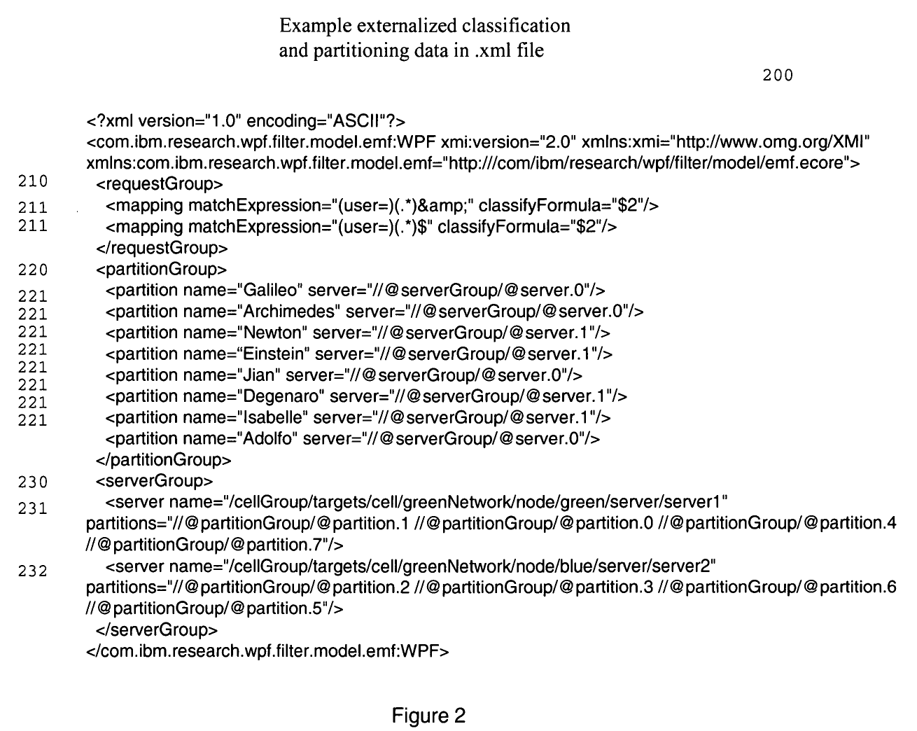

A generic session EJB, one purpose of which is to hold and report partition location information to/from applications and routers by way of reliable communication facilities, is co-deployed with the subject distributed application (170). In addition, externalized configuration data in the form of an eXtensible Markup Language (XML) file (140, 160) is also co-deployed with the subject distributed application. An example file is discussed herein below with respect to FIG. 2. One or more Java ARchive (JAR) files are deployed to augment the basic application server (171) and router (120) functionality, providing additional runtime partitioning facilities described herein.

It should be understood by one skilled in the art that any reliable multicast communication mechanism that is suitable can be used in lieu of a generic session EJB, BB, UCF, or JMS.

Subsequent to deployment, the subject distributed application (170) is started in the usual way. At runtime, requests (110) arrive at an On-Demand Router (120) for processing. The On-Demand Router (120) itself may be replicated. The On-Demand Router (120) utilizes a request classification component (130) to classify the request (110), and a request partitioning component (150) to select a server hosting a partition corresponding to the classified request. The request (110) is routed to the selected server (171) hosting the replicated distributed application (170). The replicated copy of the application (170) on the selected server operates on the request (110) in the usual way, likely reading and/or writing persistent data (180). Often a response (190) is returned by the application (170) to the requester.

The request classification component (130) employs externalized classification data (140) to perform the classification. The externalized classification data (140) is specified as a regular expression that is matched against a request (110) to classify it and determine its partition identity. Frequently, the result of the classification is identical to the desired partition identity. For example, if the request was an Hyper-Text-Transfer-Protocol (HTTP) request such as http.://odr.research.ibm.com/partition.sample.web/display.isp?user=Galileo, and the user specified classification data comprised a match expression and classification formula such as matchExpression=”(user=) (. *)&amp;”classifyFormula=“$2”/>, then the classification of the request-for-service would be into a partition named “Galileo”.

Partition names are extracted from HTTP requests using request expressions. A request expression consists of two strings: the match expression and the classifying formula. Together, they provide a mechanism for classifying HTTP requests based on Java-supported regular expressions. The match expression determines how to match on a portion of the URL and query string. The classify formula indicates the portion of the URL and query string that specifies the partition once the expression has been matched.

To determine whether an HTTP request should be partitioned, the ODR makes use of the Pattern and Matching classes of the java.util.regex package. If there is a match on any application-specified match expression, the request has an associated partition. The ODR first concatenates the URL and query string to form a single string. It invokes the Patterns built from all application-specified match expressions. Upon a match, the classify formula determines how the partition name will be built. A special character, “$”, indicates the portion of the match expression to use.

Consider a case where the match expression is “(user=)(.*)$” and the classify formula is “$2”. The “$2” will take the portion of the match corresponding to the (.*) portion, as it is the second portion of the matching pattern. For example, if the URL consists of www.ibm.com/something/user=jian, $1 would correspond to “user=”, while $2 would correspond to “jian”.

Consider the match expression “(user=)(.*)(rodriguez)$”. Suppose a request arrived with a URL containing “user=adolforodriguez”. With a classify formula of “$2”, the resulting partition name would be “adolfo”. With a classify formula of “mypartition$2”, the request would have a partition name of “mypartitionadolfo”. Likewise, with a classify formula of “$2$3”, the resulting partition name would be “adolforodriguez”.

Match expressions may overlap. For example, presume two match expressions have been specified: “(user=)(.*)$” and “(user=)(.*)&” and a URL is received with query string containing “user=adolfo&Submit=Enter”, both expressions would match. The former expression would extract “adolfo&Submit=Enter” with a $2 classify formula, while the latter would extract “adolfo”. Since only “adolfo” is a valid partition name, it would be chosen as the partition name. While it is typical that the “most specific” regular expression was the intended target, HTTP Partitioning does not make an attempt to favor a particular expression over the other. Instead, all expressions are applied until a valid partition name is found or none exists.

Request classification can occur by way of a patent application Ser. No. 10/941,789 filed on Sep. 15, 2004 and assigned to the same assignee as the instant application “Externalized Selection Middleware for Variability Management”. The latter application is incorporated herein by reference. For example, a request could be parsed for keywords which would then be used as the selection criteria for determination of the corresponding partition.

The request partitioning component (150) employs externalized partitioning data (160) to perform request partitioning (i.e., server selection for classified request based upon hosted partitions). The externalized partitioning data (160) is specified as a list of partition names and associated hosts. For example, the user specified partition data might comprise a set of (partition name, server identity) pairs such as: {(Galileo, Server 1), (Newton, Server 2), (Einstein, Server 2), (Archimedes, Server 1), (Jian, Server 1), (Degenaro, Server 2), (Isabelle, Server 2), (Adolfo, Server 1) }. Continuing the above example, the On-Demand Router (120), based upon the classification of “Galileo” and the partition mapping of “Galileo” to “Server 1” would route the subject request to “Server 1” accordingly. Here, the externally defined set of partitions associated with Server 1 are {Galileo, Archimedes, Jian, Adolfo } and those associated with Server 2 are {Newton, Einstein, Degenaro, Isabelle }.

The above example may improve horizontal scalability through recognition of disjoint writable partitions. That is, the data accessed by the application for a request mapped onto one partition has no overlap with that of any other partition. Thus, each partition can be independently located to maximize use of other resources. Presume that Server 1 begins to become CPU bound, while Server 2 has plenty of excess CPU capacity. The present invention facilitates relief by permitting movement, for example, of the partition named “Archimedes” from Server 1 to Server 2. Once moved, which can be accomplished dynamically during runtime, additional requests (specifically, those classified and associated to the “Archimedes” partition) will be sent to Server 2, thus increasing its load while decreasing the load on Server 1. And since the set of partitions have been identified as disjoint writable partitions, no increased database or disk competition will ensue.

The On-Demand Router employs both the request classification (130) and classified request partitioning (150) components to evaluate and route a request (110) to a server (171) hosting a replicated distributed application (170). A request might be an HTTP request, an Internet Inter-ORB Protocol (IIOP) request, or other suitable request.

A generic session bean and a reliable messaging mechanism are used to convey to the On-Demand Router (120) the partition locations. A generic session bean instance is associated with each replicated distributed application instance. The generic session bean instance provides the list of partitions hosted by the application (170) and the list of partitions currently hosted by the associated server (171). The generic session bean provides facilities to move a partition from one application instance to another. For example, presume partition “Galileo” is running on “Server 1”. The move command is issued to move the “Galileo” partition from “Server 1” to “Server 2”. The session beans instances on both “Server 1” and “Server 2” work in conjunction via a reliable message service to move the partition as requested, and inform the On-Demand Router (120) of the change. Additional generic session bean facilities are provided for other partition lifecycle operations including partition activation, deactivation, and status.

Further, facilities are provided to notify an application of partition change events for efficient handling. For example, an application may aggressively locally cache data relative to a hosted partition that must be flushed to persistent storage once that partition moves to another host. An application program interface (API) is provided for the notification of partition events, such as move. An application can subscribe to and unsubscribe from such event notifications. If subscribed to a move notification, when a move partition occurs through, for example, external administrative partition movement facilities, then the application is notified. Upon such notification, the application may wish to, for example, flush any aggressively cached data to persistent storage. The application itself does not participate in the definition of partitions, routing of requests, or assignment of partitions to servers.

For partition move operations, there may be some latency between the time the move commences and the time the On-Demand Router (120) is informed. That is, the On-Demand Router may have stale information with respect to partition service locations. To handle this possibility, the present invention employs a verification mechanism at the each destination server (171), whereby each partition-routed request is checked against the partitions hosted by the local server. If a match occurs, then processing continues normally. When a request is determined to be misrouted, it is redirected to the originator for retry or failure. To account for unrecoverable errors, a maximum number of redirects and/or a timeout value are associated with redirected requests. When either exceeds some corresponding threshold the request is failed. Thresholds are specifiable as externalized data.

For server failure conditions, partitions can be moved from a failed server to one that is functioning. Detection of server failure is automatically done by a monitoring mechanism component of the reliable messaging service. A scheme for distributing partitions amongst available servers can be specified externally via enumeration or formula. For example, in a simple scenario where there are 3 servers A, B, and C that are in the cluster, the cases for A only, B only, C only, A and B only, A and C only, B and C only and A, B and C together running, how the partitions 0, 1, . . . ,9 are to be located can be enumerated. For a large number of servers and partitions, an externalized formula can be specified. If not specified, the failed server's partitions can be randomly distributed across the remaining running servers. However the partitions are relocated, either by a move command or by node failure, requests that have been classified for a partition are directed to the server hosting that partition. Which server hosts a partition may change over time, and the present invention insures that a classified request is routed to the server hosting the corresponding partition wherever it may be within the group of servers known to the ODR.

Referring now to FIG. 2, an example XML file (200) containing both classification (140) and partitioning (160) data is shown. Alternatively, the classification and partitioning data can be in separate files, in a database, or other suitable persistent form accessible to the request classification (130) and request partitioning (150) components described above. The example shows a request group (210) containing two regular expression formulae (211) for classifying requests into partitions names, each specifying that user name is equivalent to partition name. Also shown is a partition group (220) comprising a list of partitions (221): Galileo, Archimedes, Newton, Einstein, Jian, Degenaro, Isabelle, and Adolfo. Further shown is a server group (230) enumeration for associating a partition with a server. In this example, partitions Galileo, Archimedes, Jian, and Adolfo are hosted by Server 1 (231), and the others are hosted by Server 2 (232).

Regular expressions can be specified for the match expressions and classify formulae (211). A user interface may restrict the expressiveness of allowed regular expressions for understandability or performance considerations, for example. A hashing function may be used as an expression so that, for example, partitions are evenly distributed across a set of servers. The set of servers may be enumerated.

A regular expression may consider one or more dimensions of a request for classification and partitioning. For example, a request may identify both a user and stock to trade, and a corresponding regular expression may utilize both pieces of information to classify the request into a partition. Any number of dimensions can be considered.

For example, a request such as https://www.e-trader.com/user=degenaro,buy=IBM,shares=100.price=90 might use corresponding values for both user (degenaro) and shares (100) to classify the request. For a request having user=degenaro and shares=100, the request might be classified as “GOLD”; for user=degenaro and shares=5000, the request might be classified as “PLATINUM”; and for user=isabelle and shares=5000 the request might be classified as “SILVER”.

A schema for the data described with respect to FIG. 2 is defined in terms of Unified Modeling Language (UML). The UML is then used to generate runtime code to perform lifecycle operations on corresponding XML file instances. The generated runtime code is employed by the request classification (130) and request partitioning (150) components to retrieve relevant classification (140) and partitioning (160) instance data respectively. Further, based upon the UML, a default instance editor can be generated to provide an easy to use mechanism for humans to revise classification (140) and partitioning (160) instance data. Revisions can be recognized on-demand at runtime, enabling dynamic behavior modification with respect to all aspects: classification, partitioning, and placement.

Dynamic changes are recognized and honored on-demand. For example, presume that a partition “Archimedes” has been associated with Server 1. Using the facilities provided by the present invention, the externalized criteria can be changed so that partition “Archimedes” is associated with Server 2. Prior to the change, requests classified and grouped into the “Archimedes” partition were routed to Server 1. Subsequent to the change, requests destined to the “Archimedes” partition are routed to Server 2.

While the foregoing is directed to the illustrative embodiment of the present invention, other and further embodiments of the invention may be devised without departing from the basic scope thereof, and the scope thereof is determined by the claims that follow.

1. In a network having a plurality of servers, a method for routing an application request to at least one of said servers hosting an application, said method comprising:
allocating each partition of an externally defined set of application associated partitions to at least one of said servers hosting said application;
classifying said application request in consideration of its contents according to external criteria;
assigning said classified application request to one of said partitions; and
routing said classified application request to one of said servers hosting said one partition.

2. A method as recited in claim 1 wherein a number of servers and a number of partitions can be scaled on demand.

3. A method as recited in claim 1, wherein allocating said partitions comprises at least one of the following steps:
activating a partition on one of said servers hosting an application;
deactivating a partition on one of said servers hosting an application;
moving a partition from one of said servers to another of said servers; and
notifying an application of partition change events.

4. A method as recited in claim 1, wherein a set of partitions comprise disjoint writable entities.

5. The method of claim 1, wherein externalized criteria comprises at least one of the following:
a partition identity;
a server identity;
a server to partition correspondence;
a formula for classifying a request into a partition; and
a formula for allocating partitions onto servers.

6. The method of claim 5, wherein said formula for classifying a request and said formula for distributing partitions are specified using at least one of the following:
an enumeration;
a regular expression;
a restricted regular expression; and
a hashing function.

7. The method of claim 5, wherein said classification formula employs multiple dimensions of a request.

8. The method of claim 1, wherein the externalized criteria are maintained persistently.

9. The method of claim 1, wherein said received request is an hyper text transfer protocol request.

10. The method of claim 1, wherein a server dynamically notifies a router of the partitions it hosts.

11. The method of claim 1, wherein a routed request is checked for correct destination partition information at one of said servers to which said request in routed and wherein at least one of the following actions is performed on said request if a partition corresponding to said request was previously moved to another one of said servers:
automatically rerouted; and
failed.

12. The method of claim 11, wherein said request will be automatically rerouted until it reaches a server which hosts said request's assigned partition or until the redirect count of said request exceeds a threshold.

13. The method of claim 11, wherein said request will be automatically rerouted until it reaches a server which hosts said request's assigned partition or until a predefined time interval has elapsed.

14. The method of claim 1, wherein the externally defined criteria correspond to a model from which user interface maintenance facilities can be automatically generated.

15. The method of claim 14, where in the model is specified according to the Unified Modeling Language.

16. The method of claim 1, wherein said received request is an Internet Inter-ORB Protocol request.

17. The method of claim 1, wherein changes to external criteria can be recognized by a running system on demand.

18. The method of claim 1, wherein said classifying, assigning, and routing steps are carried out by a software layer for routing requests between a requesting client to at least one of said servers.

19. The method of claim 1, wherein said external criteria can be specified to achieve desired application operating characteristics.

20. The method of claim 19, wherein said desired application operating characteristics comprise at least one of:
improved throughput;
improved response time; and
improved request distribution.

21. A program storage device readable by a digital processing apparatus and having a program of instructions which are tangibly embodied on the storage device and which are executable by the processing apparatus to perform a method for routing an application request to at least one of plurality of servers storing an application, said method comprising:
allocating each partition of an externally defined set of application associated partitions to at least one of said servers hosting said application;
classifying said application request in consideration of its contents according to external criteria;
assigning said classified application request to one of said partitions; and
routing said classified application request to one of said servers hosting said one partition.

22. A system for routing an application request to at least one of a plurality of servers hosting an application, said system comprising:
means for allocating each partition of an externally defined set of application associated partitions to at least one of said servers hosting said application;
means for classifying said application request in consideration of its contents according to external criteria;
means for assigning said classified application request to one of said partitions; and
a router for routing said classified application request to one of said servers hosting said one partition.
